(19) United States
(12) Patent Application Publication
(10) Pub. No.: US 2020/0240211 A1
(43) Pub. Date: Jul. 30, 2020

(54) LADDER EDGE GUARD

(71) Applicants: Travis Klass Jerrom, Burnaby (CA); Sandra Nieto Rios, Burnaby (CA)

(72) Inventors: Travis Klass Jerrom, Burnaby (CA); Sandra Nieto Rios, Burnaby (CA)

(21) Appl. No.: 16/751,845

(22) Filed: Jan. 24, 2020

Related U.S. Application Data
(60) Provisional application No. 62/796,160, filed on Jan. 24, 2019.

(51) Int. Cl. E06C 7/48

(52) U.S. Cl. CPC E06C 7/48

(57) ABSTRACT

A ladder edge guard providing a means for preventing damage caused by a ladder on siding or other surfaces and to help prevent the ladder from slipping. The guard may clip onto a ladder's side rail leading edge, and may be provided in a variety of lengths, including 12-inch pieces and 16-inch pieces. The ladder edge guard pieces are manufactured of thermoplastic, such as a flexible 80 durometer polyvinyl chloride (PVC), and have an asymmetrical design that can be manufactured in a variety of sizes to fit different ladder profiles.

### CROSS-REFERENCE TO RELATED APPLICATION

The present application is related to and claims priority from prior provisional application Ser. No. 62/796,160, filed Jan. 24, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The present invention relates generally to the field of ladder safety devices and more specifically relates to a ladder edge guard providing a means for preventing damage caused by a ladder on railings or other surfaces. The guard is clipable or otherwise attachable onto a ladder's side rail leading edge, and is provided in various lengths, including 12 inch pieces. The guard is preferable manufactured of polyvinyl chloride (PVC).

### 2. Description of the Related Art

A ladder is a vertical or inclined set of rungs or steps. There are two types: rigid ladders that are either self-supporting or that may be leaned against a vertical surface such as a wall, and rollable ladders, such as those made of rope or aluminum, that may be hung from the top. Rigid ladders are usually portable, but some types are permanently fixed to a structure, building, or equipment. They are commonly made of metal, wood, or fiberglass, but alternatively may be made of a tough plastic material.

Factory built extension ladders are designed to be used on flat, level surfaces, leaning against a parallel exterior and at an angle of 4:1. Unfortunately, the problem is that many extension ladders are used outdoors on a wide variety of terrain that is not always a good combination for safe use of the ladder. If the ground is sloped on one side of the ladder, the top will slide sideways off the wall surface. If the feet are on a smooth and slippery surface, the ladder will slide away from the wall at the bottom. These are the primary reasons for extension ladder falls.

Various attempts have been made to solve problems found in ladder safety device art. Among these are found in: U.S. Pat. No. 6,945,359 to John LoGiudice; U.S. Pub. No. 2009/0211843 to Stephen T. McClain; U.S. Pub. No. 2013/0239388 to Daniel Edward Striepling; U.S. Pat. No. 3,419,109 to Costlow et al.; U.S. Pat. No. 5,058,789 to William D. Piper. This prior art is representative of ladder safety and damage prevention devices.

None of the above inventions and patents, taken either singly or in combination, is seen to describe the invention as claimed. Thus, a need exists for a reliable Ladder Edge Guard, a ladder edge guard providing a means for preventing damage caused by a ladder on railings or other surfaces.

### BRIEF SUMMARY OF THE INVENTION

In view of the foregoing disadvantages inherent in the known ladder safety device art, the present invention provides a novel ladder edge guard. The general purpose of the present invention, which will be described subsequently in greater detail, is to provide a ladder edge guard providing a means for preventing damage caused by a ladder on railings or other surfaces. The guard may clip onto a ladder's side rail leading edge, may be provided in pieces with various lengths, including 12 inches and 16 inches, and is preferably manufactured of PVC. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, Ladder Edge Guard, constructed and operative according to the teachings of the present invention.

FIG. 1 shows a perspective view illustrating a pair of ladder edge guards attached to a ladder, according to an embodiment of the presently claimed invention.

FIG. 2 shows a perspective view illustrating the short arm of a ladder edge guard, according to an embodiment of the presently claimed invention.

FIG. 3 shows a perspective view illustrating the long arm of a ladder edge guard, according to an embodiment of the presently claimed invention.

FIG. 4 shows a rendering illustrating dimensions of a ladder edge guard, according to an embodiment of the presently claimed invention.

FIG. 5 shows a rendering illustrating dimensions of two sizes of ladder edge guards, according to two embodiments of the presently claimed invention.

FIG. 6 shows a perspective view illustrating a ladder edge guard, according to an embodiment of the presently claimed invention.

FIGS. 7A-7C show perspective views illustrating adding a ladder edge guard to a ladder railing by a user, according to an embodiment of the presently claimed invention

FIG. 8 shows a perspective view illustrating removal of a ladder edge guard by a user, according to an embodiment of the presently claimed invention.

The various embodiments of the present invention will hereinafter be described in conjunction with the appended drawings.

### DETAILED DESCRIPTION

As discussed above, embodiments of the present invention relate to a ladder safety device and more particularly to a Ladder Edge Guard.

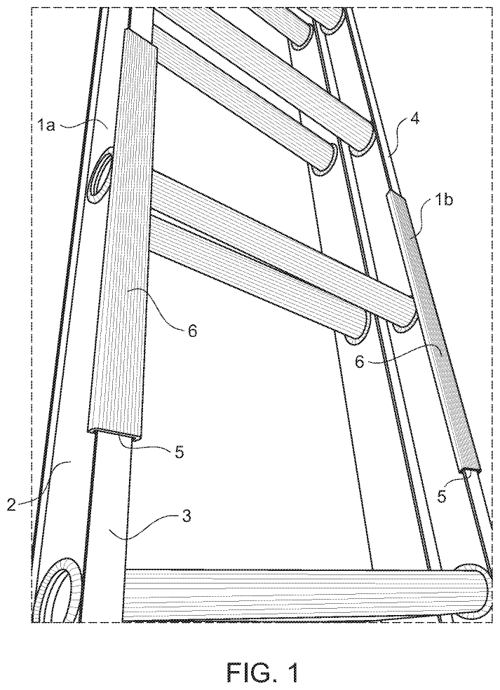

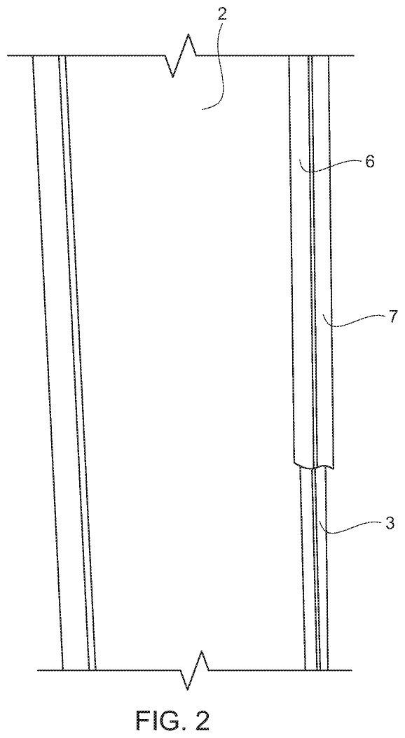

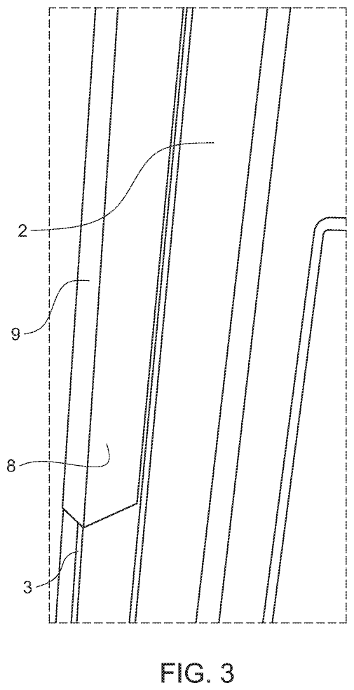

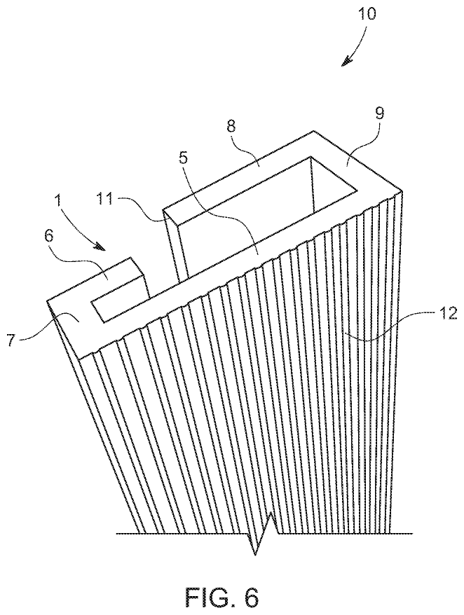

Referring now to the drawings FIGS. 1-8, the ladder edge guard is a novel product that offers consumers a practical solution to the aforementioned challenges. As the name implies, the ladder edge guard is a device specially designed to protect any surface the extension ladder is placed against such as a balcony railing, eavestrough (gutters), walls, finished wood or metal, etc., and to provide improved anti-slip properties in order to prevent the ladder from sliding sideways along any surface the ladder is placed against. The ladder edge guards are removeable, but can remain attached to a ladder, or be permanently attached to a ladder, if needed. There may be multiples sizes, lengths, dimensions, and designs of different ladder edge guard profiles, as each ladder manufacturer has their own design of ladder rail profile, although some edge guards will fit different brands of ladders that share similar profile dimensions.

As shown in FIGS. 1-3 and 6-8, the components of the ladder edge guard 1 are two edge guard pieces 1a, 1b that are attachable to the outer edges of the extension ladder's 2 left and right side rails 3, 4, preferably formed of extruded PVC.

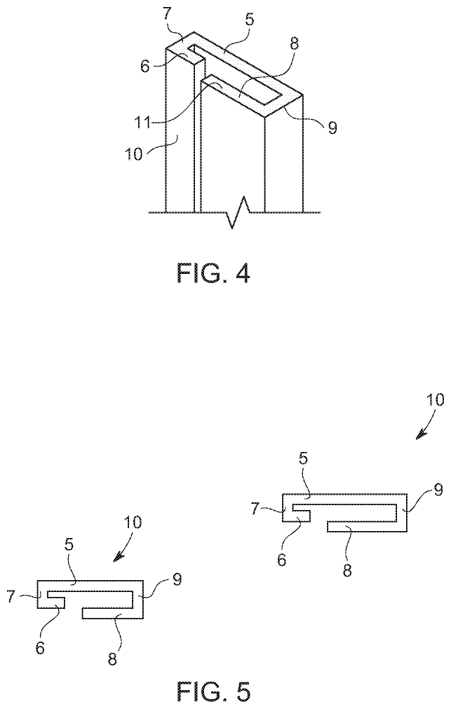

The ladder edge pieces 1a, 1b is preferably manufactured by creating a metal die that creates an extrusion of PVC. The extrusion is manufactured in one long length and then cut into the desired lengths, preferably 12-inch lengths or longer. Each edge piece 1a, 1b simply clips onto one of the ladder's 1a, 1b side rail leading edge 3, 4. Each edge piece 1a, 1b is shaped to match the contours of a specific brands' extension ladder, as shown in FIG. 4, but may be manufactured in two or more different sizes to fit wider railed extension ladders as well, as shown in FIG. 5. It is also made of a soft enough material that allows the profile to bend so it can be clipped on and off easily by hand. The Ladder Edge Guard is cost-effective to produce in the embodiments, as shown in FIGS. 1-7.

As shown in FIGS. 4-5, each of the two edge guard pieces 1a, 1b have a front width 5, a short arm 6 at the back side 10 with a thinner depth 7, and a long arm 8 at the back side 10 with a thicker depth 9. The ladder edge guard 1 can be manufactured in a variety of sizes and specific designs, including an asymmetrical design with a front width 5 of 31 mm, and a thicker depth 9 on one side of 11 mm, with a long arm 8 of 18 mm at the back side, and a thinner depth 7 of 8 mm on the opposing side of the width 5, with a short arm 6 of 8 mm at the back side 10. A larger sized ladder edge guard 1 may have an asymmetrical design with a front width 5 of 36 mm, and a thick depth 9 on one side of 11 mm, with a long arm 8 of 23 mm at the back side 10, and a thinner depth 7 on the opposing side of the width 5 of 8 mm, with a short arm 6 of 8 mm at the back side. The overall thickness profile 11 of the PVC that forms the edge guard pieces 1a, 1b, is 3 mm.

As shown in FIGS. 1-3 and 6-8, the ladder edge guard 1 is made of a flexible plastic material, preferably of a flexible 80 durometer PVC material. The plastic material preferably has a 3 mm thick profile 11. There is an anti-slip corrugated detail 12 that runs parallel with the length of each edge guard piece 1a, 1b on the outside face of the front width 5 of the edge guard. The anti-slip corrugated detail 12 on the front width 5 is the surface the ladder edge guard 1 that comes in contact with any surface the ladder 2 is set against to protect the surface and prevent the ladder 2 from sliding sideways. The edge guard lengths are preferably 12 inches in length, but may be manufactured in other lengths as needed.

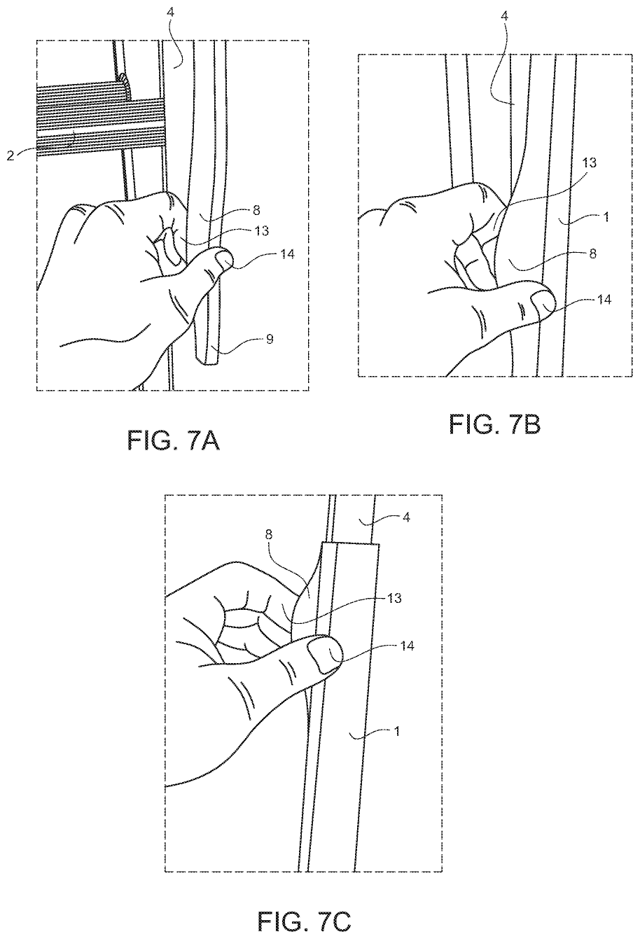

As shown in FIGS. 7A-7C, the flexible plastic material that forms the ladder edge guard 1 has an excellent memory that allows the ladder edge guard 1 to be stretched to fit around the profile of the ladder side rails 3, 4. In order to install, a user hooks the short arm 6 of one of the edge guard pieces 1a, 1b around one of the outer edges of the ladder side rail 3, 4 at the bottom of the edge guard piece 1, and pulls the long arm 8 of the ladder edge guard 1 away so the long arm 8 of the ladder edge guard 1 slips around the back edge of the ladder rail 3. Once the bottom of the edge guard 1 is snapped into place on the ladder side rail's outer edge 3, 4, the user continues moving his or her finger's 13 upward while applying pressure to the long 8 of the ladder edge guard 1 with his or her thumb 14, pressing the ladder edge guard 1 into place on the ladder edge rail 3, 4 all the way to the top of the edge guard 1. Once completely in place, the ladder edge guard 1 is slidable up and down the ladder rails 3, 4 to any location where protection is needed.

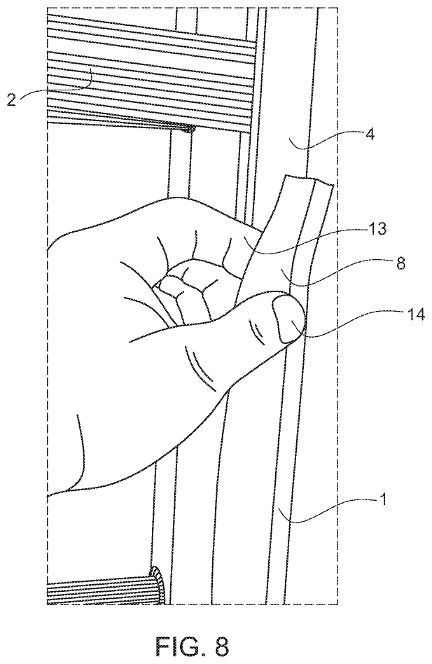

As shown in FIG. 8, a user removes the ladder edge guard 1 by pinching the inside of the long arm 8 of the ladder edge guard 1 between his or her fingers 13 and thumb 14 and sliding his or her fingers 13 down behind this arm 8 of the ladder edge guard 1 until the ladder edge guard 1 pulls away from the ladder rail 4. The user then continues to pull downwards until the ladder edge guard 1 pulls off the ladder 2 completely.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclos

What is claimed is new and desired to be protected by Letters Patent is set forth in the appended claim:

1. A ladder edge safety and damage prevention device comprising:
(a) at least one ladder edge guard piece formed from a flexible plastic material having
(i) a length;
(ii) a front width with an anti-slip corrugated detail, wherein the anti-slip corrugated detail runs parallel with the length;
(iii) a short arm parallel to the front width operably connected by a first depth from the front width;
(iv) a long arm parallel to the front width operably connected by a second depth from the front width; and
(v) a thickness profile,
wherein the second depth is greater than the first depth,
wherein the short arm and the long arm of at least one ladder edge guard piece are removably attachable over a ladder rail.

2. The ladder edge safety and damage prevention device according to claim 1, having two ladder edge guard pieces.

3. The ladder edge safety and damage prevention device according to claim 1, wherein the flexible plastic material is a flexible 80 durometer polyvinyl chloride material.

4. The ladder edge safety and damage prevention device according to claim 1, wherein the length is twelve inches.

5. The ladder edge safety and damage prevention device according to claim 1, wherein the length is sixteen inches.

6. The ladder edge safety and damage prevention device according to claim 1, wherein the thickness profile is 3 mm.

7. The ladder edge safety and damage prevention device according to claim 1, wherein the front width is 31 mm, the short arm is 8 mm, the first depth is 8 mm, the long arm is 18 mm, and the second depth is 11 mm.

8. The ladder edge safety and damage prevention device according to claim 1, wherein the front width is 36 mm, the short arm is 8 mm, the first depth is 8 mm, the long arm is 23 mm, and the second depth is 11 mm.

9. A method of removeably attaching the ladder edge safety and damage prevention device according to claim 1, the method comprising:
(a) providing a first ladder edge guard piece according to claim 1
(b) providing a second ladder edge guard piece according to claim 1;
(c) providing a ladder with a first ladder rail and a first rail edge and a second ladder rail and a second rail edge;
(d) hooking the short arm of one of the first edge guard pieces around a first side of the first ladder rail edge;
(e) pulling the long arm of the first ladder edge guard out and around a second side of the first rail edge so the long arm slides around a back edge of the first ladder rail;
(f) continuing to pull the long arm of the ladder edge guard piece out and around the second side of the first rail edge in an upwards direction while pressing the ladder edge guard piece into place at the front width so that the front width is flat against the surface of the first rail edge; and
(g) repeating steps (d)-(f) with the second ladder edge guard piece on the second ladder rail and second rail edge.

10. A method of removing the ladder edge safety and damage prevention device according to claim 1, the method comprising:
(a) providing a ladder with a ladder rail and a rail edge, with the ladder edge guard piece according to claim 1 attached thereon;
(b) pinching an inside of the long arm of the ladder edge guard piece between one or more of a user's fingers and the user's thumb;
(c) pulling the long arm away from the ladder rail;
(d) sliding the user's fingers behind the long arm until the ladder edge guard piece pulls away from the ladder rail; and
(e) pulling downwards until the ladder edge guard piece pulls off the ladder completely.

11. A ladder edge safety and damage prevention device comprising:
(a) two ladder edge guard pieces formed from a flexible 80 durometer polyvinyl chloride material, each ladder edge guard piece having
(i) a length of twelve inches;
(ii) a front width with an anti-slip corrugated detail, wherein the anti-slip corrugated detail runs parallel with the length;
(iii) a short arm parallel to the front width operably connected by a first depth from the front width;
(iv) a long arm parallel to the front width operably connected by a second depth from the front width; and
(v) a thickness profile of 3 mm,
wherein the second depth is greater than the first depth,
wherein the short arm and the long arm of the at least one ladder edge guard piece are removably attachable over a ladder rail.

12. The ladder edge safety and damage prevention device according to claim 11, wherein the front width is 31 mm, the short arm is 8 mm, the first depth is 8 mm, the long arm is 18 mm, and the second depth is 11 mm.

13. The ladder edge safety and damage prevention device according to claim 11, wherein the front width is 36 mm, the short arm is 8 mm, the first depth is 8 mm, the long arm is 23 mm, and the second depth is 11 mm.
